(19) United States
(12) Patent Application Publication
(10) Pub. No.: US 2015/0242220 A1
(43) Pub. Date: Aug. 27, 2015

(54) MASSIVE VIRTUAL DESKTOP PROVIDING METHOD AND SYSTEM THEREOF

(71) Applicant: ELECTRONICS AND TELECOMMUNICATIONS RESEARCH INSTITUTE, Daejeon (KR)

(72) Inventors: Soo-Cheol OH, Daejeon (KR); Dae-Won KIM, Daejeon (KR); Sun-Wook KIM, Cheongju-si (KR); Jong-Bae MOON, Daejeon (KR); Jung-Hyun CHO, Daejeon (KR); Seong-Woon KIM, Gyeryong-si (KR); Hag-Young KIM, Daejeon (KR)

(73) Assignee: ELECTRONICS AND TELECOMMUNICATIONS RESEARCH INSTITUTE, Daejeon (KR)

(21) Appl. No.: 14/630,701

(22) Filed: Feb. 25, 2015

(30) Foreign Application Priority Data
Feb. 26, 2014 (KR) 10-2014-0022695

(51) Int. Cl. G06F 9/44

(52) U.S. Cl. CPC G06F 9/4445; G06F 2209/549

(57) ABSTRACT

Exemplary embodiments of the present invention relate to a method and system for providing massive virtual desktops. A system for providing massive virtual desktops according to an embodiment of the present invention comprises a uppermost layer configured to receive a virtual desktop providing request from a client, search an adjacent lower layer involved in a virtual desktop service for the client, and transmit the virtual desktop providing request to the searched adjacent lower layer; and a lowest layer configured to receive the virtual desktop providing request transmitted from an adjacent upper layer, search a virtual desktop to perform a service by analyzing the virtual desktop providing request, and transmit the searched virtual desktop to the client. According to embodiments of the present invention, a virtual desktop can be provided to massive users.

### CROSS REFERENCE TO RELATED APPLICATION

This application claims the benefit of Korean Patent Application No. 10-2014-0022695, filed on Feb. 26, 2014, entitled “Massive virtual desktop providing method and system thereof”, which is hereby incorporated by reference in its entirety into this application.

### BACKGROUND

1. Technical Field

Exemplary embodiments of the present invention relate to a method and system for providing virtual desktops.

2. Description of the Related Art

A virtual desktop providing service is a service which a client can connect to a server and use a virtual machine existing in the server. Use of the virtual desktop providing service is increasing due to easy system management and security enhancement.

A general virtual desktop providing service is a service to provide virtual desktops to members in a system from a server which is in the system. However, such a general virtual desktop providing service has limits to provide virtual desktops to massive users.

### SUMMARY

Exemplary embodiments of the present invention are to provide a virtual desktop to massive users.

A system for providing massive virtual desktops according to an embodiment of the present invention may comprise a uppermost layer configured to receive a virtual desktop providing request from a client, search an adjacent lower layer involved in a virtual desktop service for the client, and transmit the virtual desktop providing request to the searched adjacent lower layer; and a lowest layer configured to receive the virtual desktop providing request transmitted from an adjacent upper layer, search a virtual desktop to perform a service by analyzing the virtual desktop providing request, and transmit the searched virtual desktop to the client.

In an embodiment, the uppermost layer may search an adjacent lower layer from an established database by using a client identifier included in the virtual desktop providing request. For example, the uppermost layer may search an adjacent lower layer from a first database mapped with client identifiers and virtual desktop identifiers and a second database mapped with virtual desktop identifiers and adjacent lower layer identifiers.

In an embodiment, the uppermost layer may include the virtual desktop identifier corresponding to the client into the virtual desktop providing request and transmit the result to the adjacent lower layer. The lowest layer may search the virtual desktop corresponding to the virtual desktop identifier included in the virtual desktop providing request and transmit the result to the client.

In an embodiment, the system may further comprise at least one middle layer configured to analyze the virtual desktop providing request received from the adjacent upper layer, search an adjacent lower layer involved in a virtual desktop service for the client who requested the virtual desktop providing request, and transmit the virtual desktop providing request to the searched adjacent lower layer.

In an embodiment, the middle layer may search an adjacent lower layer from an established database by using a virtual desktop identifier included in the virtual desktop providing request. For example, the middle layer may search an adjacent lower layer from a database mapped with virtual desktop identifiers and adjacent lower layer identifiers.

In an embodiment, the middle layer may perform at least one operation of transmitting a control command received from an adjacent upper layer to an adjacent lower layer, transmitting command execution result received from the adjacent lower layer to the adjacent upper layer, and performing the control command received from the adjacent upper layer.

A method for providing massive virtual desktops according to an embodiment of the present invention may comprise: receiving a virtual desktop providing request from a client by a uppermost layer; searching an adjacent lower layer involved in a virtual desktop service for the client by the uppermost layer; and transmitting the virtual desktop providing request to the searched adjacent lower layer by the uppermost layer; receiving the virtual desktop providing request transmitted from the adjacent upper layer by a lowest layer; searching a virtual desktop to perform a service by analyzing the virtual desktop providing request by the lowest layer; and transmitting the searched virtual desktop to the client by the lowest layer.

In an embodiment, the searching an adjacent lower layer may comprise searching an adjacent lower layer from an established database by using a client identifier included in the virtual desktop providing request. For example, the searching an adjacent lower layer may comprise: searching a virtual desktop identifier corresponding to a client identifier included in the virtual desktop providing request from a first database mapped with client identifiers and virtual desktop identifiers; and searching an adjacent lower layer identifier corresponding to the searched virtual desktop identifier from a second database mapped with virtual desktop identifiers and adjacent lower layer identifiers.

In an embodiment, the transmitting the virtual desktop providing request may comprise including the virtual desktop identifier corresponding to the client into the virtual desktop providing request and transmitting the result to the adjacent lower layer. For example, the transmitting the virtual desktop may comprise searching the virtual desktop corresponding to the virtual desktop identifier included in the virtual desktop providing request and transmitting the result to the client.

In an embodiment, the method may further comprise analyzing the virtual desktop providing request received from the adjacent upper layer by a middle layer, searching an adjacent lower layer involved in a virtual desktop service for the client who requested the virtual desktop providing request by the middle layer, and transmitting the virtual desktop providing request to the searched adjacent lower layer by the middle layer.

In an embodiment, the searching an adjacent lower layer by the middle layer may comprise searching an adjacent lower layer from an established database by using a virtual desktop identifier included in the virtual desktop providing request. For example, the searching an adjacent lower layer by the middle layer may comprise searching an adjacent lower layer from a database mapped with virtual desktop identifiers and adjacent lower layer identifiers.

In an embodiment, the method may further comprise at least one of transmitting a control command received from an adjacent upper layer to an adjacent lower layer by the middle layer, transmitting command execution result received from the adjacent lower layer to the adjacent upper layer, and performing the control command received from the adjacent upper layer.

According to embodiments of the present invention, virtual desktops may be provided to massive users.

### BRIEF DESCRIPTION OF THE DRAWINGS

FIG. 1 illustrates an example of a network configuration for providing virtual desktops according to an embodiment of the present invention.

FIG. 2 illustrates an example for explaining hierarchical structure of a big platform according to an embodiment of the present invention.

FIG. 3A and FIG. 3B illustrate an example for explaining a database which is used for lower layer searches according to an embodiment of the present invention.

FIG. 4 is a flowchart for explaining a virtual desktop providing method according to an embodiment of the present invention.

FIG. 5 is a block view briefly illustrating a big platform for providing virtual desktops according to an embodiment of the present invention.

FIG. 6 is a block view for explaining the uppermost layer according to an embodiment of the present invention.

FIG. 7A and FIG. 7B are block view for explaining a middle layer according to an embodiment of the present invention.

FIG. 8 is a block view for explaining a lower layer according to an embodiment of the present invention.

FIG. 9 is a block view for explaining a big platform server agent according to an embodiment of the present invention.

### DESCRIPTION OF THE EXEMPLARY EMBODIMENTS

Throughout the description of the present invention, when describing a certain technology is determined to evade the point of the present invention, the pertinent detailed description will be omitted.

Hereinafter, exemplary embodiments of the present invention will be described below in more detail with reference to the accompanying drawings.

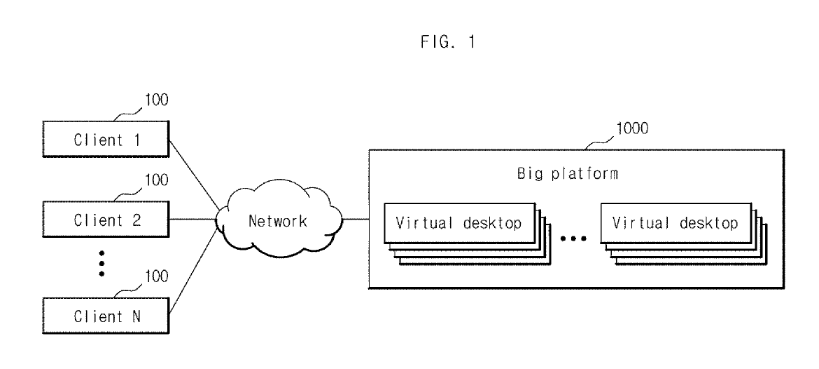

FIG. 1 illustrates an example of a network configuration for providing virtual desktops according to an embodiment of the present invention.

Referring to FIG. 1, a client 100 may connect to a platform which provides a virtual desktop through network such as internet based on a user's request. A virtual desktop service may be provided to a user by receiving a virtual desktop from a corresponding platform. In the description of embodiments of the present invention below, a platform which provides a virtual desktop to a client is called as a big platform 1000.

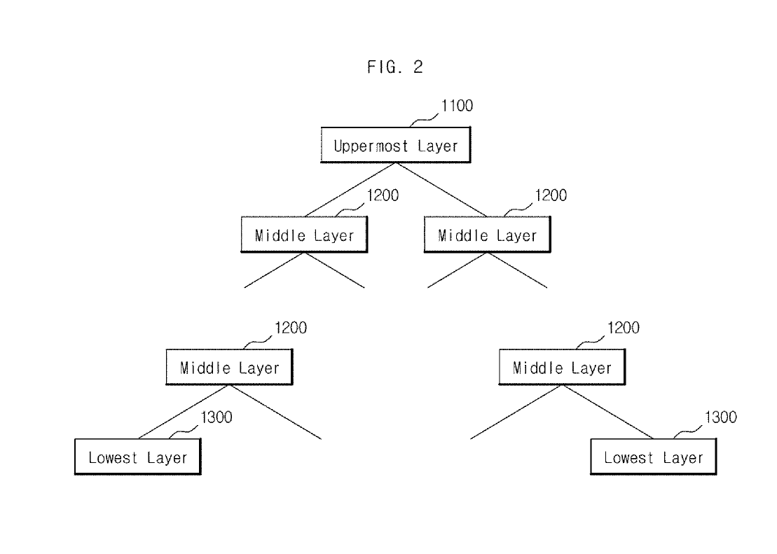

In embodiments of the present invention, the big platform 1000 may have a hierarchical structure to provide a virtual desktop to massive users. This will be described with reference to FIG. 2.

FIG. 2 illustrates an example for explaining hierarchical structure of a big platform according to an embodiment of the present invention.

The big platform according to an embodiment of the present invention may have a hierarchical structure which is a tree structure. In an embodiment, the big platform may include at least one of the uppermost layers 1100, at least one of middle layers 1200 and at least one of the lowest layers 1300. At least one component thereof may be omitted.

The uppermost layer 1100 may, when a virtual desktop providing request is received from a client, search an adjacent lower layer involved in a virtual desktop service for the corresponding client. The following is an example for explaining search for an adjacent lower layer by the uppermost layer 1100.

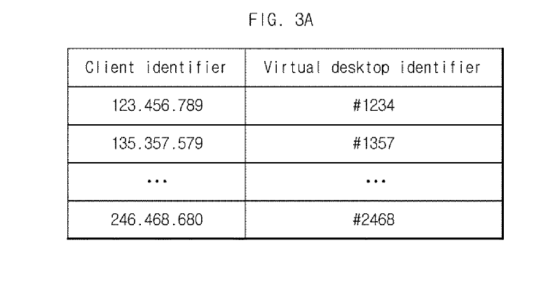

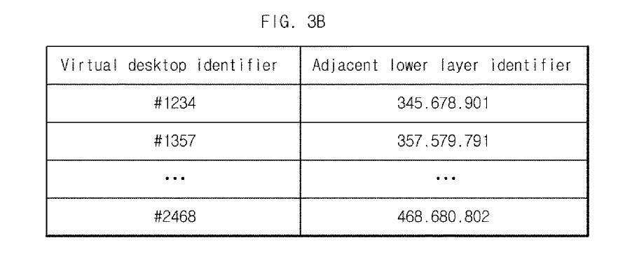

A virtual desktop providing request received from a client may include an identifier of the client. The identifier may be various types for identifying the client. For example, it may be an Internet protocol (IP) address or a media access control (MAC) address, or a user ID. The uppermost layer 1100 may search an adjacent lower layer from an established database by using the client identifier included in the virtual desktop providing request. The uppermost layer 1100 may have a database which is used for searching an adjacent lower layer. For example, the database may include a first database mapped with client identifiers and virtual desktop identifiers as shown in FIG. 3A. In addition, the database may include a second database mapped with virtual desktop identifiers and adjacent lower layer identifiers as shown in FIG. 3B. The uppermost layer 1100 may search a virtual desktop identifier corresponding to the client identifier included in a virtual desktop providing request from the first database. It may also search an adjacent lower layer identifier corresponding to the search virtual desktop identifier from the second database.

The uppermost layer 1100 may transmit the virtual desktop providing request to the adjacent lower layer corresponding to the searched adjacent lower layer identifier. Here, the uppermost layer 1100 may include the virtual desktop identifier searched from the first database into the virtual desktop providing request and transmit the result.

Here, the adjacent lower layer of the uppermost layer 1100 may be a middle layer 1200. If there is no middle layer 1200, the adjacent lower layer of the uppermost layer 1100 may be the lowest layer 1300.

In the description of exemplary embodiments of the present invention, involving in a virtual desktop service means performing at least one of generating, deleting, processing or transmitting commands, monitoring statuses, storing or transmitting information, and providing or managing a virtual desktop before or after a virtual desktop is provided.

The lowest layer 1300 may, when a virtual desktop providing request is received from an adjacent upper layer, analyze the received virtual desktop providing request and search a virtual desktop to provide a service. In an embodiment, a virtual desktop identifier may be included in the virtual desktop providing request received from the adjacent upper layer and the lowest layer 1300 may search a virtual desktop to provide the service to the client by using the corresponding virtual desktop identifier.

The lowest layer 1300 may transmit the searched virtual desktop to the client. The client identifier may be included in the virtual desktop providing request received from the adjacent upper layer and the lowest layer 1300 may transmit a virtual desktop to the client by using the corresponding identifier.

Here, the adjacent upper layer of the lowest layer 1300 may be a middle layer 1200. If there is no middle layer 1200, the adjacent upper layer of the lowest layer 1300 may be the uppermost layer 1100.

The middle layer 1200 may analyze the virtual desktop providing request received from the adjacent upper layer and search the adjacent lower layer involved in the virtual desktop service for the client who requested the virtual desktop providing request. Explanation of an embodiment for searching an adjacent lower layer by a middle layer 1200 is as follows.

A virtual desktop identifier may be included in the virtual desktop providing request received from an adjacent upper layer. The middle layer 1200 may search an adjacent lower layer from an established database by using the virtual desktop identifier included in the virtual desktop providing request. The middle layer 1200 may have the database which is used for searching the adjacent lower layer. For example, the database may be a database mapped with virtual desktop identifiers and adjacent lower layer identifiers as shown in FIG. 3B. The middle layer 1200 may search an adjacent lower layer identifier corresponding to the virtual desktop identifier included in the virtual desktop providing request from the database.

The middle layer 1200 may transmit the virtual desktop providing request to the adjacent lower layer corresponding to the searched adjacent lower layer identifier.

After the virtual desktop is transmitted from the lowest layer 1300 to the client, the middle layer 1200 may transmit a control command or information received from an adjacent upper layer to an adjacent lower layer. In addition, the middle layer 1200 may transmit control command execution results or information received from the adjacent lower layer to the adjacent upper layer. In addition, the middle layer 1200 may perform a control command received from an adjacent upper layer. In addition, the middle layer 1200 may monitor statuses and generate, store or transmit information (including status monitoring information) to an adjacent upper layer or an adjacent lower layer.

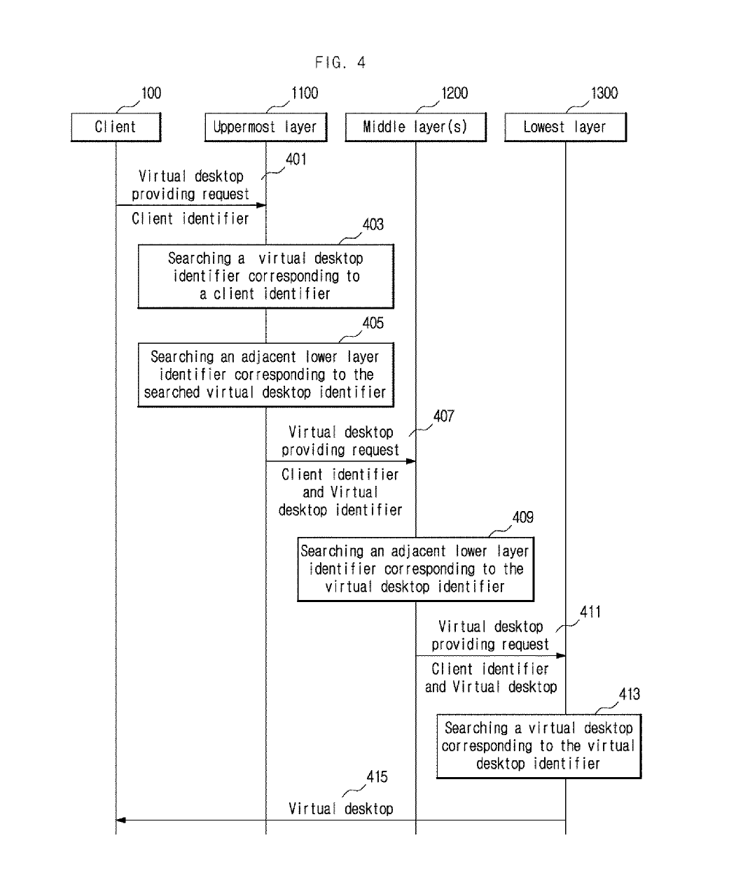

FIG. 4 is a flowchart for explaining a virtual desktop providing method according to an embodiment of the present invention.

In Step 401, the uppermost layer 1100 receives a virtual desktop providing request from the client 100. An identifier for the client may be included in the virtual desktop providing request received from the client 100.

In Step 403, the uppermost layer 1100 may search a virtual desktop identifier corresponding to the client identifier included in the virtual desktop providing request with reference to an established database. For example, the database may be a first database mapped with client identifiers and virtual desktop identifiers as explained with reference to FIG. 3A.

In Step 405, the uppermost layer 1100 may search an adjacent lower layer identifier corresponding to the searched virtual desktop identifier with reference to an established database. The database may be a second database mapped with virtual desktop identifiers and adjacent lower layer identifiers as explained with reference to FIG. 3B.

In Step 407, the uppermost layer 1100 may transmit the virtual desktop providing request to an adjacent lower layer corresponding to the searched adjacent lower layer identifier. Here, the uppermost layer 1100 may include the searched virtual desktop identifier into the virtual desktop providing request and transmit the result.

In Step 409, the middle layer 1200 may search an adjacent lower layer identifier corresponding to the virtual desktop identifier included in the virtual desktop providing request with reference to an established database. The database may be a database mapped with virtual desktop identifiers and adjacent lower layer identifiers as explained with reference to FIG. 3B.

In Step 411, the middle layer 1200 may transmit the virtual desktop providing request to an adjacent lower layer corresponding to the searched adjacent lower layer identifier.

In Step 413, the lowest layer 1300 may search a virtual desktop corresponding to the virtual desktop identifier included in the virtual desktop providing request. Here, the lowest layer 1300 may have a database in which virtual desktops are stored by identifiers.

In Step 415, the lowest layer 1300 may transmit the searched virtual desktop to the client. This transmission may be carried based on the client identifier included in the virtual desktop providing request.

Although it has been described that at least one middle layer 1200 between the uppermost layer 1100 and the lowest layer 1300 in the exemplary embodiment of the present invention described hereinabove, the middle layer 1200 may not exist according to another exemplary embodiment. In this case, Steps from 407 to 411 may be omitted and the uppermost layer 1100 may transmit the virtual desktop providing request directly to the lowest layer 1300.

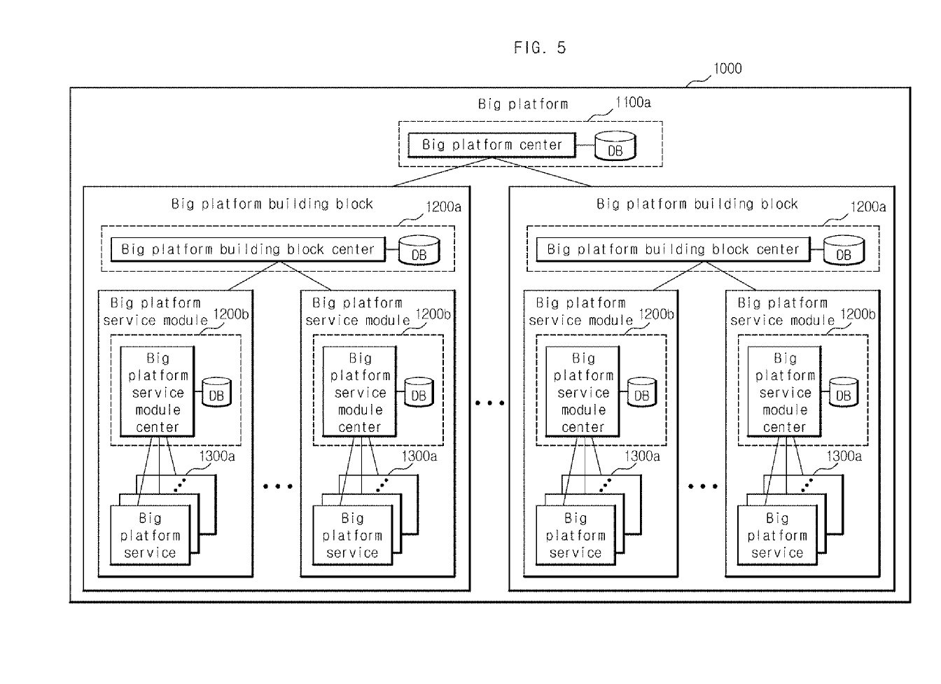

FIG. 5 is a block view briefly illustrating a big platform for providing virtual desktops according to an embodiment of the present invention.

FIG. 5 illustrates a big platform configured with 4 layers. However, the big platform may be configured with 2 layers or a plurality of layers.

A layer 1100a configured with a big platform center and a database is a layer corresponding to the uppermost layer 1100 in FIG. 2.

A layer 1200a configured with a big platform building block center and a database and a layer 1200b configured with a big platform service module center and a database are layers corresponding to the middle layer 1200 in FIG. 2.

A layer 1300a of a big platform server is a layer corresponding to the lowest layer 1300 in FIG. 2.

As shown in FIG. 5, the layers, except the lowest layer, have at least one adjacent lower layer and a database which is used to search an adjacent lower layer.

Structures of each layer will be explained in more detail with reference to the relating drawings.

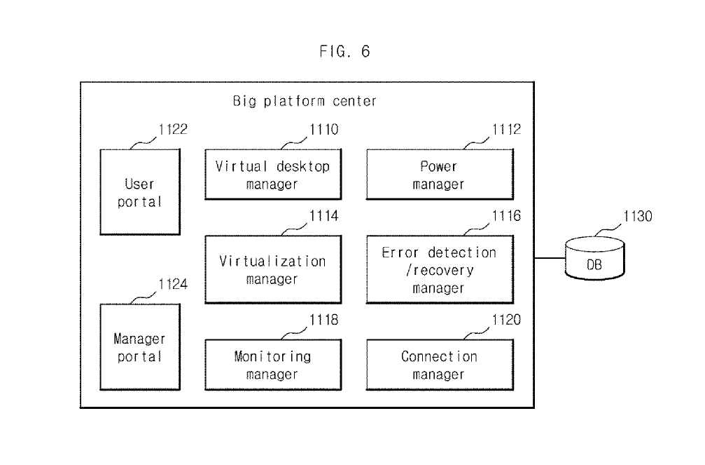

FIG. 6 is a block view for explaining the uppermost layer according to an embodiment of the present invention.

A big platform center included in the uppermost layer according to an embodiment of the present invention manages the entire big platform center and includes a virtual desktop manager 1110, a power manager 1112, a virtualization manager 1114, an error detection/recovery manager 1116, a monitoring manager 1118, a connection manager 1120, a user portal 1122, a manager portal 1124, and a database 1130. At least one of those elements may be omitted.

The virtual desktop manager 1110 manages a virtual desktop, generates various commands to manage the virtual desktop and transmits them to various interfaces, and receives information about corresponding command processing result from a corresponding interface. The commands may be commands of virtual desktop start, shut down, pause, resume and the like.

The power manager 1112 may send a power management command to the big platform server on the basis of user connection statuses, system loads and the like. The power management command may be commands such as system on, system off, system suspend and the like.

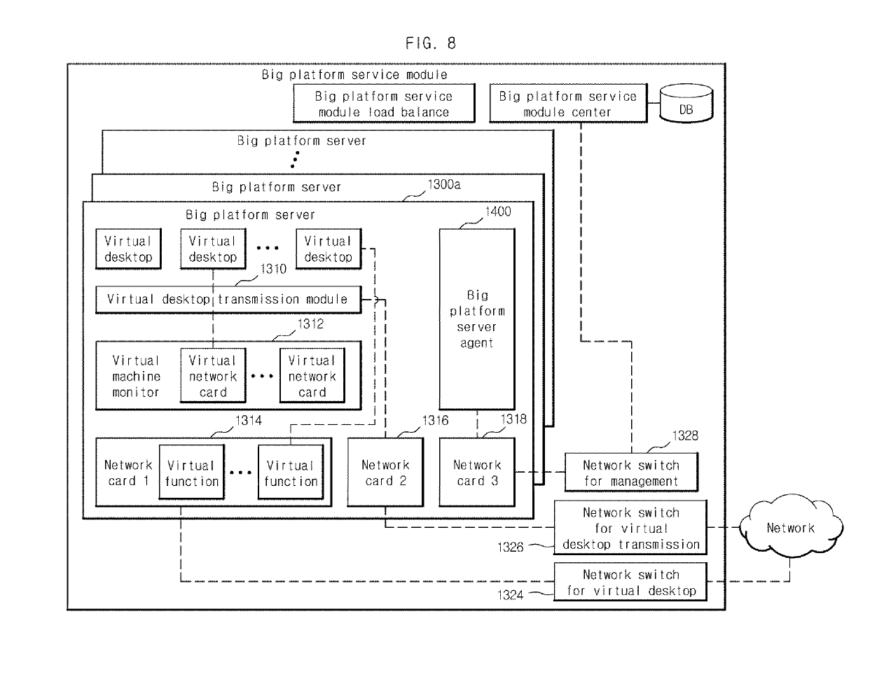

The virtualization manager 1114 may manage a virtual machine monitor 1312 and a virtual desktop transmission module 1310 illustrated in FIG. 8, generate commands to manage and transmit them to various interfaces, and receive information about corresponding command processing result from the interfaces.

The error detection/recovery manager 1116 may detect an error of the internal big platform from monitoring results which is obtained by the monitoring manager 1118 and transmit commands to recover the errors to various interfaces.

The monitoring manager 1118 may perform monitoring its lower layers which are a big platform building block, a big platform service module, a big platform server and a virtual desktop. Monitoring information may be stored in the database 1130.

The connection manager 1120 may, when a user connects to the big platform, search the big platform building block, in which a virtual desktop which can server for the client is located, to connect it to the user.

The user portal 1122 and the manager portal 1124 provide interfaces for a user and a manager to access to the big platform.

The user portal 1122 may be used to perform at least one function of user authentication, virtual desktop connection, catalogue, virtual desktop error solution and the like.

The manager portal 1124 may be used to perform at least one function of user account creation/deletion/change, virtual desktop creation/deletion/change/backup, big platform monitoring and big platform resource management and the like.

The database 1130 may store mapping information of a big platform building block which servers each virtual desktop and a corresponding virtual desktop. The database 1130 may also store monitoring information of the big platform and management policies for the big platform building block.

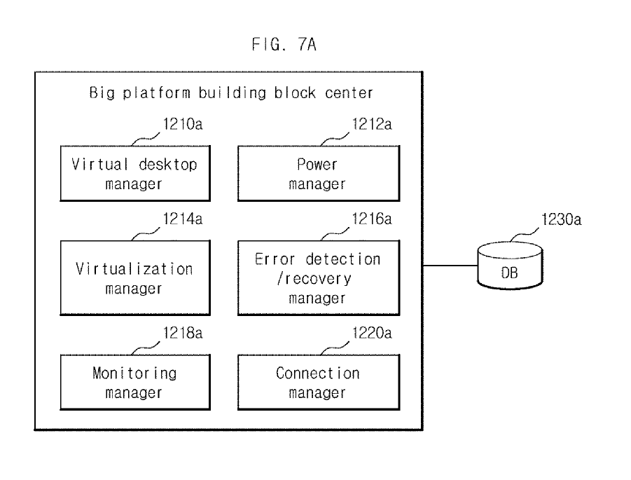

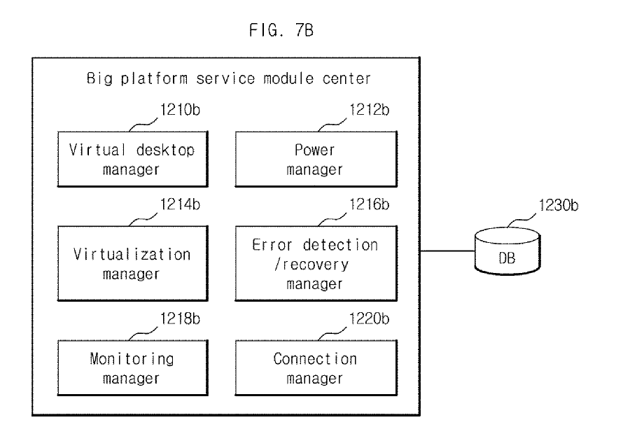

FIG. 7A and FIG. 7B are block view for explaining a middle layer according to an embodiment of the present invention.

A big platform building block center included in the middle layer according to an embodiment of the present invention may manage a big platform service module and include a virtual desktop manager 1210a, a power manager 1212a, a virtualization manager 1214a, an error detection/recovery manager 1216a, a monitoring manager 1218a, a connection manager 1220a and a database 1230a as shown in FIG. 7A. At least one component thereof may be omitted.

The virtual desktop manager 1210a may process a command received from a virtual desktop manager of the big platform center and transmit command processing result to the virtual desktop manager of the big platform center. The virtual desktop manager 1210a may transmit a command received from the virtual desktop manager of the big platform center to a virtual desktop manager of a big platform service module center and also transmit command processing result received from the virtual desktop manager of the big platform service module center to the virtual desktop manager of the big platform center.

The power manager 1212a may process a command received from a power manager of the big platform center and transmit command processing result to the power manager of the big platform center. The power manager 1212a may transmit a command received from the power manager of the big platform center to a power manager of the big platform service module center and also transmit command processing result received from the power manager of the big platform service module center to the power manager of the big platform center.

The virtualization manager 1214a may process a command received from a virtualization manager of the big platform center and also transmit command processing result to the virtualization manager of the big platform center. The virtualization manager 1214a may transmit a command received from the virtualization manager of the big platform center to the virtualization manager of the big platform service module center and also transmit command processing result received from the virtualization manager of the big platform service module center to the virtualization manager of the big platform center.

The error detection/recovery manager 1216a may detect an error of the big platform service module based on monitored information and transmit error detection result of the error detection/recovery manager of the big platform center. The error detection/recovery manager 1216a may process a command received from the error detection/recovery manager of the big platform center and also transmit command processing result to the error detection/recovery manager of the big platform center.

The monitoring manager 1218a may monitor the big platform building block center and transmit the monitored information to the monitoring manager of the big platform center. The monitoring manager 1218a may transmit the monitored information received from the monitoring manager of the big platform service module to the monitoring manager of the big platform center.

The connection manager 1220a may, when a virtual desktop providing request is received from a corresponding building block, search a big platform service module which is able to provide a virtual desktop and then connect the searched big platform service module to a user.

The database 1230a may store mapping information of the big platform service module which provides each virtual desktop and a corresponding virtual desktop. The database 1230a may also store management policies for the big platform building block.

The big platform service module center included in the middle layer according to an embodiment of the present invention may manage a big platform server and include a virtual desktop manager 1210b, a power manager 1212b, a virtualization manager 1214b, an error detection/recovery manager 1216b, a monitoring manager 1218b, a connection manager 1220b and a database 1230b as shown in FIG. 7B. At least one component thereof may be omitted.

The virtual desktop manager 1210b may process a command received from the virtual desktop manager of the big platform building block and transmit command processing result to the virtual desktop manager of the big platform building block. The virtual desktop manager 1210b may transmit a command received from the virtual desktop manager of the big platform building block and also transmit command processing result received from the virtual desktop manager of the big platform server agent and also transmit command processing result received from the virtual desktop manager of the big platform server agent to the virtual desktop manager of the big platform building block.

The power manager 1212b may process a command received from the power manager of the big platform building block and transmit command processing result to the power manager of the big platform building block. The power manager 1212b transmit a command received from the power manager of the big platform building block to the power manager of the big platform server agent and also transmit command processing result received from the power manager of the big platform server agent to the power manager of the big platform building block.

The virtualization manager 1214b may process a command received from the virtualization manager of the big platform building block and transmit command processing result to the virtualization manager of the big platform building block. The virtualization manager 1214b may transmit a command received from the virtualization manager of the big platform building block to the virtualization manager of the big platform server agent and also transmit command processing result received from the virtualization manager of the big platform server agent to the virtualization manager of the big platform building block.

The error detection/recovery manager 1216b may detect an error of the big platform server based on the monitored information and transmit error detection result to the error detection/recovery manager of the big platform building block center. The error detection/recovery manager 1216b may process a command received from the error detection/recovery manager of the big platform building block center and transmit command processing result to the error detection/recovery manager of the big platform building block center.

The monitoring manager 1218b may monitor the big platform service module center and transmit the monitored information to the monitoring manager of the big platform building block center. The monitoring manager 1218b may transmit monitored information received from the monitoring manager of the big platform server agent to the monitoring manager of the big platform building block center.

The connection manager 1220b may, when a virtual desktop providing request is received from a corresponding service module, search the big platform server which is able to provide a corresponding virtual desktop and connect the searched big platform server to a user.

The database 1230b may store mapping information of the big platform server which provides each virtual desktop and a corresponding virtual desktop. The database 1230b may also store management policies for the big platform server.

FIG. 8 is a block view for explaining a lower layer according to an embodiment of the present invention.

A big platform server 1300a included in the lowest layer according to an embodiment of the present invention provides a virtual desktop service and includes a virtual desktop transmission module 1310, a virtual machine monitor 1312, network cards 1314, 1316, 1318 and a big platform server agent 1400. At least one component thereof may be omitted.

The virtual desktop transmission module 1310 may transmit a virtual desktop to a client.

The virtual machine monitor 1312 may execute a plurality of virtual desktops on the big platform server by using virtualization functions.

The virtual desktop may use network for various virtual desktops. For example, the virtual desktop may use a virtual network interface card (vNIC) which the virtual machine monitor 1312 provides by software emulation. The virtual desktop may use a virtual function (VF) which provides network cards by hardware virtualization. A network which the virtual desktop uses may be changed depending on network use demands and big platform server statuses.

The network card 1 1314 is connected to a network through a network switch for the virtual desktop 1324 to execute intranet or internet inside the virtual desktop.

The network card 2 1316 is used for the virtual desktop transmission module 1310 to transmit a virtual desktop to a client and is connected to a network through a network switch for the virtual desktop transmission 1326.

The network card 3 1318 may be used for transmitting/receiving commands, monitored information and the like between a big platform server agent 1400 and a big platform service module center and is connected to the big platform service module center through a network switch for management 1328.

The big platform server agent 1400 may process a command received from the big platform service module center and transmit command processing result to the big platform service module center. The big platform server agent 1400 may monitor statuses of the virtual desktop and the big platform server and also transmit monitored results to the big platform service module center.

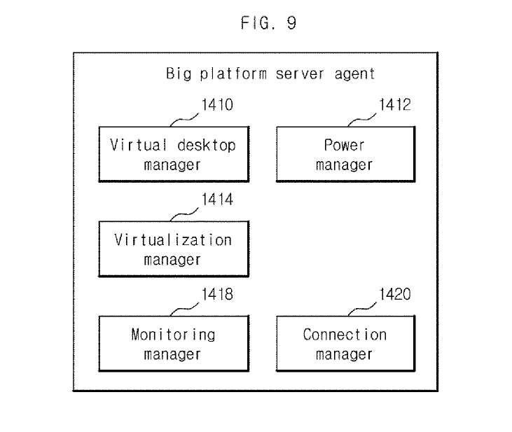

FIG. 9 is a block view for explaining a big platform server agent according to an embodiment of the present invention.

A big platform server agent according to an embodiment of the present invention includes a virtual desktop manager 1410, a power manager 1412, a virtualization manager 1414, a monitoring manager 1418 and a connection manager 1420. At least one component may be omitted.

The virtual desktop manager 1410 may process a command received from the virtual desktop manager of the big platform service module and transmit command processing result to the virtual desktop manager of the big platform service module.

The power manager 1412 may process a command received from the power manager of the big platform service module and transmit command processing result to the power manager of the big platform service module.

The virtualization manager 1414 may process a command received from the virtualization manager of the big platform service module and transmit command processing result to the virtualization manager of the big platform service module.

The monitoring manager 1418 may monitor the big platform server and the virtual desktop and transmit monitored results to the monitoring manager of the big platform service module.

The connection manager 1420 may, when a virtual desktop providing request is received to a server, search a corresponding virtual desktop and transmit the searched virtual desktop to a user.

The exemplary embodiment of the present invention can be implemented by various methods. For example, the exemplary embodiment of the present invention can be implemented by using hardware, software or its combination.

When they are implemented by software, they may be implemented as software executing in more than one processors using various operating systems or platforms. In addition, the software may be created by using any language among various appropriate programming languages or be compiled in machine language codes or intermediate codes executable in a framework or virtual machine.

In addition, when the exemplary embodiment of the present invention is executed in more than one processors, the exemplary embodiment of the present invention may be implemented by processor readable media such as a memory, a floppy disk, a hard disk, a compact disk (CD), an optical disk or a magnetic tape, or the like in which more than one programs are recorded to conduct the implementation of various exemplary embodiments of the present invention.

What is claimed is:

1. A massive virtual desktop providing system comprising:
a uppermost layer configured to receive a virtual desktop providing request from a client, search an adjacent lower layer involved in a virtual desktop service for the client, and transmit the virtual desktop providing request to the searched adjacent lower layer; and
a lowest layer configured to receive the virtual desktop providing request transmitted from an adjacent upper layer, search a virtual desktop to perform a service by analyzing the virtual desktop providing request, and transmit the searched virtual desktop to the client.

2. The massive virtual desktop providing system of claim 1, wherein the uppermost layer searches an adjacent lower layer from an established database by using a client identifier included in the virtual desktop providing request.

3. The massive virtual desktop providing system of claim 2, wherein the uppermost layer searches an adjacent lower layer from a first database mapped with client identifiers and virtual desktop identifiers and a second database mapped with virtual desktop identifiers and adjacent lower layer identifiers.

4. The massive virtual desktop providing system of claim 1, wherein the uppermost layer includes the virtual desktop identifier corresponding to the client into the virtual desktop providing request and transmits the result to the adjacent lower layer.

5. The massive virtual desktop providing system of claim 4, wherein the lowest layer searches a virtual desktop corresponding to the virtual desktop identifier included in the virtual desktop providing request and transmits the result to the client.

6. The massive virtual desktop providing system of claim 1, further comprising at least one middle layer configured to analyze the virtual desktop providing request received from the adjacent upper layer, search an adjacent lower layer involved in a virtual desktop service for the client who requested the virtual desktop providing request, and transmit the virtual desktop providing request to the searched adjacent lower layer.

7. The massive virtual desktop providing system of claim 6, wherein the middle layer searches an adjacent lower layer from an established database by using a virtual desktop identifier included in the virtual desktop providing request.

8. The massive virtual desktop providing system of claim 7, wherein the middle layer searches an adjacent lower layer from a database mapped with virtual desktop identifiers and adjacent lower layer identifiers.

9. The massive virtual desktop providing system of claim 6, wherein the middle layer performs at least one operation of transmitting a control command received from an adjacent upper layer to an adjacent lower layer, transmitting command execution result received from the adjacent lower layer to the adjacent upper layer, and performing the control command received from the adjacent upper layer.

10. A massive virtual desktop providing method comprising:
receiving a virtual desktop providing request from a client by a uppermost layer;
searching an adjacent lower layer involved in a virtual desktop service for the client by the uppermost layer; and
transmitting the virtual desktop providing request to the searched adjacent lower layer by the uppermost layer;
receiving the virtual desktop providing request transmitted from the adjacent upper layer by a lowest layer;
searching a virtual desktop to perform a service by analyzing the virtual desktop providing request by the lowest layer; and
transmitting the searched virtual desktop to the client by the lowest layer.

11. The massive virtual desktop providing method of claim 10, wherein the searching an adjacent lower layer comprises searching an adjacent lower layer from an established database by using a client identifier included in the virtual desktop providing request.

12. The massive virtual desktop providing method of claim 11, wherein the searching an adjacent lower layer comprises:
searching a virtual desktop identifier corresponding to a client identifier included in the virtual desktop providing request from a first database mapped with client identifiers and virtual desktop identifiers; and
searching an adjacent lower layer identifier corresponding to the searched virtual desktop identifier from a second database mapped with virtual desktop identifiers and adjacent lower layer identifiers.

13. The massive virtual desktop providing method of claim 10, wherein the transmitting the virtual desktop providing request comprises including the virtual desktop identifier corresponding to the client into the virtual desktop providing request and transmitting the result to the adjacent lower layer.

14. The massive virtual desktop providing method of claim 13, wherein the transmitting the virtual desktop comprises searching the virtual desktop corresponding to the virtual desktop identifier included in the virtual desktop providing request and transmitting the result to the client.

15. The massive virtual desktop providing method of claim 10, further comprising:
analyzing the virtual desktop providing request received from the adjacent upper layer by a middle layer,
searching an adjacent lower layer involved in a virtual desktop service for the client who requested the virtual desktop providing request by the middle layer, and
transmitting the virtual desktop providing request to the searched adjacent lower layer by the middle layer.

16. The massive virtual desktop providing method of claim 15, wherein the searching an adjacent lower layer by the middle layer comprises searching an adjacent lower layer from an established database by using a virtual desktop identifier included in the virtual desktop providing request.

17. The massive virtual desktop providing method of claim 16, wherein the searching an adjacent lower layer by the middle layer comprises searching an adjacent lower layer from a database mapped with virtual desktop identifiers and adjacent lower layer identifiers.

18. The massive virtual desktop providing method of claim 15, further comprising at least one of transmitting a control command received from an adjacent upper layer to an adjacent lower layer, transmitting command execution result received from the adjacent lower layer to the adjacent upper layer, and performing the control command received from the adjacent upper layer by the middle layer.
